(19) United States
(12) Patent Application Publication
(10) Pub. No.: US 2012/0095594 A1
(43) Pub. Date: Apr. 19, 2012

(54) SYSTEMS AND METHODS FOR USE IN CHARGING AN ELECTRICALLY POWERED VEHICLE

(76) Inventors: Konstantin Vladimir Grigoryan, Louisville, KY (US); John Kenneth Hooker, Louisville, KY (US)

(21) Appl. No.: 13/221,234

(22) Filed: Aug. 30, 2011

(51) Int. Cl. G06F 17/00

(52) U.S. Cl. 700/237

(57) ABSTRACT

Methods and systems for use in charging an electrically powered vehicle are disclosed. One example method includes transmitting, by a charging station, an authorization request message to a charging system host, receiving a return message from the charging system host in response to the authorization request message, and transmitting, by the charging station, a charge terminate message to the charging system host in response to a charge terminate event. The authorization request message includes a charging station identification and a vehicle identification of a vehicle coupled to the charging station. The charge terminate message includes the charging station identification and at least one of a vehicle connection time and a charge time.

### BACKGROUND OF THE INVENTION

The subject matter disclosed herein relates generally to charging electrically powered vehicles and, more specifically, to systems and methods for use in communicating authorization and/or transaction information.

Electrically powered vehicles, including electric vehicles and plug-in hybrid electric vehicles, include electric motors powered from energy storage devices, such as batteries. As electrically powered vehicles operate, the energy storage devices contained therein are depleted.

The energy storage devices are commonly re-charged at vehicle charging stations to enable further use of the vehicle. Some known vehicle charging stations are provided for public or private use. Information is often provided to the charging station prior to charging the vehicle. The charging station generally checks the information against information stored within the charging system prior to permitting the vehicle to be charged. When the information contained in charging stations is updated, each charging station is individually updated with current information regarding vehicles and/or users permitted to charge at the charging station.

### BRIEF DESCRIPTION OF THE INVENTION

In one aspect, a computer based method for communicating with a charging system host is provided. The method includes transmitting, by a charging station, an authorization request message to a charging system host, receiving a return message from the charging system host in response to the authorization request message, and transmitting, by the charging station, a charge terminate message to the charging system host in response to a charge terminate event. The authorization request message includes a charging station identification and a vehicle identification of a vehicle coupled to the charging station. The charge terminate message includes the charging station identification and at least one of a vehicle connection time and a charge time.

In another aspect, a charging station for communicating with a charging system host is provided. The charging station includes a memory device storing a charge station identification, a communication interface for communicating with a charging system host through a network, and a processor electrically coupled to the memory device and to the communication interface. The processor is programmed to transmit, via the communication interface, an authorization request message to a charging system host, receive a return message from the charging system host in response to the authorization request message, and transmit, via the communication interface, a charge terminate message to a charging system host in response to a charge terminate event. The authorization request message includes the charging station identification and a vehicle identification of a vehicle coupled to the charge station. The charge terminate message includes the charging station identification and at least one of a vehicle connection time and a charge time.

### BRIEF DESCRIPTION OF THE DRAWINGS

FIG. 1 is a block diagram of an exemplary computing device.

FIG. 2 is a block diagram of an exemplary electrically powered vehicle charging system.

FIG. 3 is a flowchart of an exemplary method for use in communicating with a charging system host.

FIG. 4 is a flowchart of another exemplary method for use in communicating with a charging system host.

### DETAILED DESCRIPTION OF THE INVENTION

The embodiments described herein relate to communication of information between a charging system host and a plurality of vehicle charging stations. More specifically, some embodiments relate to communicating authorization and/or transaction information between a charging station and a charging system host through a network.

An exemplary technical effect of the methods, systems, and apparatus described herein includes at least one of (a) transmitting, by a charging station, an authorization request message to a charging system host, (b) receiving a return message from the charging system host in response to the authorization request message, and (c) transmitting, by the charging station, a charge terminate message to the charging system host in response to a charge terminate event. The authorization request message includes a charging station identification and a vehicle identification for a vehicle coupled to the charging station. The charge terminate message includes the charging station identification and at least one of a vehicle connection time and a charge time.

In numerous embodiments, the term “electrically powered vehicle” refers generally to a vehicle that includes one or more electric motors that are used for propulsion. Energy used to propel electrically powered vehicles may come from various energy storage devices, such as, but not limited to, an on-board rechargeable battery, a capacitor, and/or an on-board fuel cell. In one embodiment, the electrically powered vehicle is a hybrid electric vehicle, which may include both an electric motor and a combustion engine. In another embodiment, an electrically powered vehicle is an electric vehicle, which may include only an electric motor for propulsion. Electrically powered vehicles may capture and store energy generated, for example, by braking. Moreover, some electrically powered vehicles are capable of recharging the energy storage device from a power receptacle, such as a power outlet. Accordingly, the term “electrically powered vehicle” as used herein may refer to any vehicle that includes an energy storage device to which electrical energy may be delivered, for example, via a power grid.

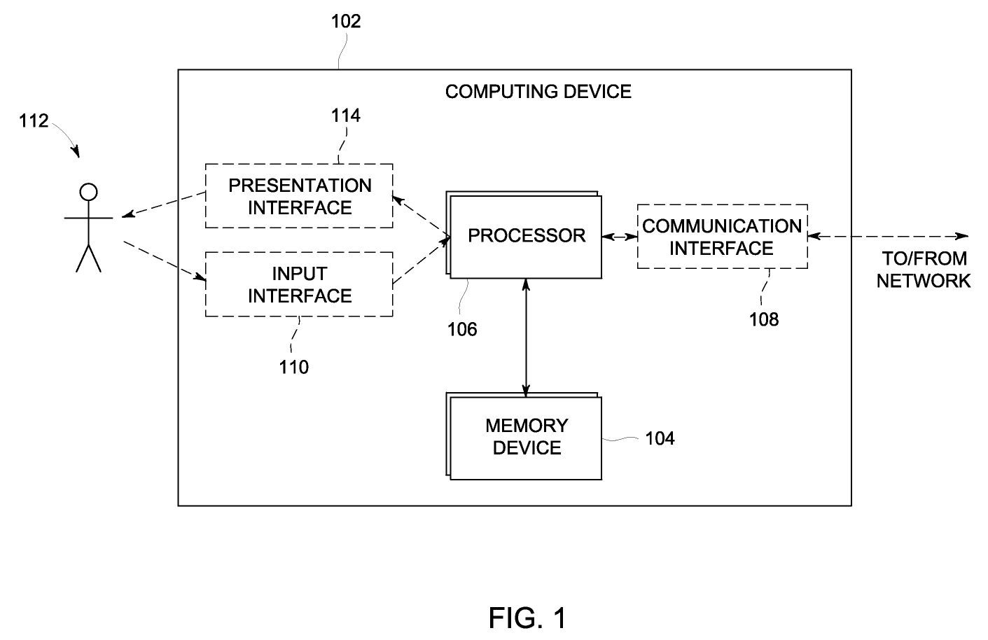

FIG. 1 illustrates an example computing device 102. In the exemplary embodiment, computing device 102 includes a memory device 104 and a processor 106 coupled to memory device 104. In some embodiments, executable instructions are stored in memory device 104 and executed by processor 106 to perform one or more operations described herein by programming processor 106 accordingly.

Memory device 104 is one or more devices operable to enable information such as executable instructions and/or other data to be stored and/or recalled. In one embodiment, memory device 104 includes one or more computer readable media, such as, without limitation, hard disk storage, optical drive/disk storage, removable disk storage, flash memory, non-volatile memory, ROM, EEPROM, random access memory (RAM), etc. Memory device 104 may be configured to store, without limitation, computer-executable instructions, charging station identifications, vehicle identifications, payment account information, and/or any other type of data. Memory device 104 may be incorporated in and/or separate from processor 106.

In one embodiment, processor 106 includes one or more processing units (e.g., in a multi-core configuration). The term processor, as used herein, refers to central processing units, microprocessors, microcontrollers, reduced instruction set circuits (RISC), application specific integrated circuits (ASIC), logic circuits, and any other circuit or processor capable of executing instructions to perform functions described herein.

Computing device 102 includes a communication interface 108 coupled to processor 106. Communication interface 108 is configured to be coupled in communication with one or more other devices, such as another computing device 102, a network, etc. Communication interface 108 may include, without limitation, a serial communication adapter, a wired network adapter, a wireless network adapter, a mobile network adapter, a radio frequency (RF) receiver, a keyless entry receiver, and/or any other device capable of communicating with one or more other devices. Communication interface 108 includes one or more device suitable to transmit information to and/or receive information from one or more devices. In one example, communication interface 108 of computing device 102 transmits multiple messages to and/or from a charging system host through a wired or wireless network.

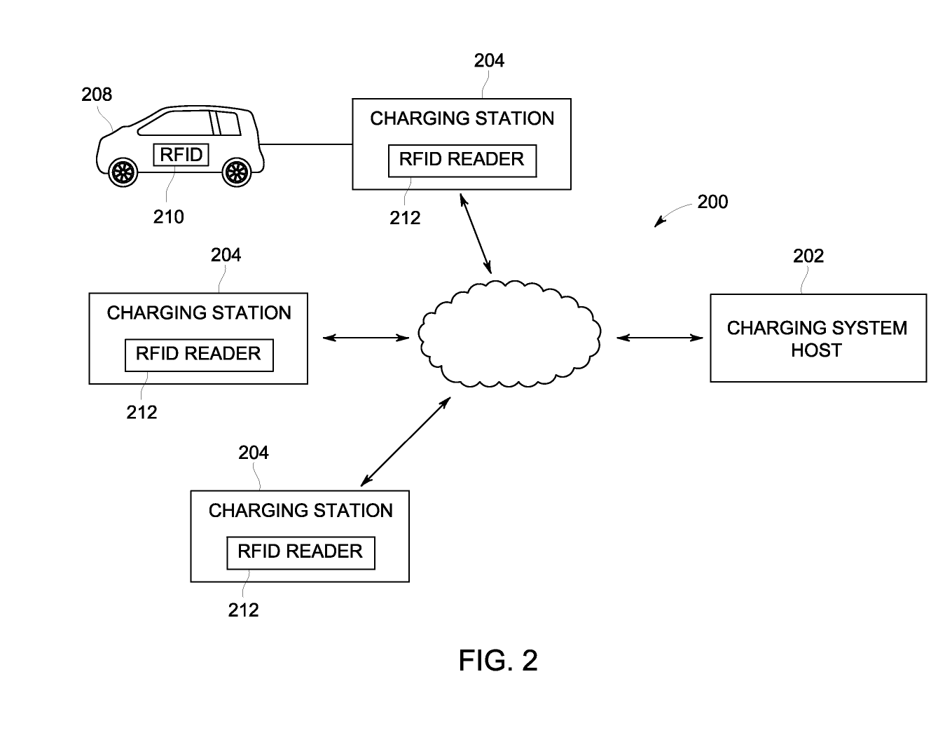

In some exemplary embodiments, computing device 102 includes an input interface 110 configured to receive one or more inputs from a user 112, such as an administrator of an electrically powered vehicle charging system (e.g., as illustrated in FIG. 2) or an operator of an electrically powered vehicle. Input interface 110 may include, without limitation, a button, a knob, a keypad, a keyboard, a pointing device, a mouse, a radio frequency identification (RFID) card reader, a touch sensitive panel (e.g., a touch pad or a touchscreen), a gyroscope, a position detector, and/or an audio input (e.g., a microphone).

As shown in FIG. 1, computing device 102 includes a presentation interface 114, such as a cathode ray tube (CRT), a liquid crystal display (LCD), an organic LED (OLED) display, an “electronic ink” display, and/or other device suitable to display information. In some embodiments, presentation interface 114 includes a display of a charging station accessible to a user 112. Additionally, or alternatively, presentation interface 114 includes an audio output device (e.g., an audio adapter and/or a speaker, etc.). In various embodiments, presentation interface 114 and input interface 110 are incorporated into a single component, such as a touchscreen display.

FIG. 2 illustrates an exemplary electrically powered vehicle charging system 200, which includes a charging system host 202 and three charging stations 204 coupled to charging system host 202 through a network 206. As should be apparent, a different number and/or arrangement of charging stations 204 may be employed in other system embodiments. In the exemplary embodiment, charging system host 202 and charging stations 204 are examples of computing device 102 as illustrated in FIG. 1.

Network 206 includes a wired and/or wireless network such as, without limitation, the Internet, a local area network (LAN), a wide area network (WAN), a wireless LAN (WLAN), an Ethernet network, a mesh network, a virtual private network (VPN), a cellular network, a Wi-Fi network, and/or any other network that enables system 200 to function as described herein. Charging system host 202 transmits messages to, and receives messages from, one or more of charging stations 204 through network 206. Likewise, charging stations 204 transmit messages to, and receive messages from, charging system host 202 through network 206.

In the exemplary embodiment, one or more of charging system host 202 and charging stations 204 include static network addresses, such as an Internet protocol (IP) address. The static network address may provide convenient and efficient setup, administration, and/or operation of charging system host 202, charging stations 204, and/or network 206. In other embodiments, charging system host 202 and/or charging stations 204 include dynamic network addresses, in which charging system host 202 and/or charging stations 204 are identified on network 206 through a unique identifier, such as machine names.

As illustrated, an electrical powered vehicle 208 is coupled to one of charging stations 204 to facilitate charging of electrically powered vehicle 208. In the exemplary embodiment, one of charging station 204 and vehicle 208 initiates a charging process. In one example, vehicle 208 initiates a charging process by providing vehicle specific data to input interface 110 of charging station 204. For example, an operator presents a radio-frequency identification (RFID) card 210 to charging station 204 to provide a vehicle identification. Additionally, or alternatively, charging station 204 detects the presence of vehicle 208, such as by detecting the RFID card 210 associated vehicle 208. Specifically, as illustrated, each charging station 204 includes a RFID reader 212, which may detect the presence of vehicle 208 and/or read a vehicle identification, as described below, from the RFID card 210. In at least one embodiment, one of charging station 204 and vehicle 208 detects the other when a charging cable is coupled therebetween.

Regardless of whether communication is initiated by charging station 204 or vehicle 208, charging station 204 receives a vehicle identification associated with vehicle 208 and/or its operator. More specifically, the vehicle identification may be specific to the vehicle and/or specific to the operator. In one example, the vehicle identification is specific to the operator (and not to vehicle 208), such that the operator is able to utilized the vehicle identification with different vehicles 208. The vehicle identification may include any identification, such as, for example, a numeric code, an alpha code, and/or an alpha-numeric code distinguishing vehicle 208 from other vehicles and/or associating vehicle 208 to a group of vehicles 208. In one example, the vehicle identification is read from the RFID card (e.g., the RFID card number) by RFID reader 212. In another example, multiple vehicles 208 associated with a common function may be grouped under the same vehicle identification, so that authorization to charge at a particular time and/or place may be conveniently administered for the entire group.

After acquiring the vehicle identification for vehicle 208, charging station 204 transmits an authorization request message to charging system host 202. The authorization request message includes the vehicle identification. Additionally, the authorization request message may include other information. Specifically, for example, the authorization request message includes a message type and a charge station identification. In this particular embodiment, the message type is set to “0” to indicate the message is an authorization request. Other exemplary message type values are described below. In other embodiments, the authorization request message may include more or less data related to charging station 204 and/or vehicle 208. For example, in at least one embodiment, the authorization request message includes a station locality identification, a station facility identification, and a RFID card number length. The station locality identification indicates a geographic location of charging station 204 (e.g., a city, a street, neighborhood, zip code, etc.), while the station facility indicates a facility associated with charging station 204.

In response to the authorization request message, charging system host 202 transmits one or more return messages. In one embodiment, in response to an authorization request message, charging system host transmits either 0x0001 indicating successful authorization or 0x8002 indicating a failed authorization. As should be apparent, the specific format and number of bytes included in the response message may be different in other embodiments. For example, in various embodiments, the return message includes a date and/or a time at which the authorization request message was received and/or a date and/or a time at which the return message was transmitted. In one example, a return message includes year/month/date/time in twelve (12) bytes. The time is provided in a 24-hour format and based on the local time of charging system host 202. In other embodiments, the date and/or the time includes more or less information in a variety of formats. In still other embodiments, the date and/or the time is omitted from the return message.

Whether charging system host 202 grants or denies authorization to charge is based on a number of factors, which may include, without limitation, a type of vehicle 208, an association of vehicle 208 with a group, a location of charging station 204, a time, and/or a designation of a user of vehicle 208, etc. In some embodiments, authorization may be linked to one or more payment accounts for charging time connected to charging station 204 and/or energy consumed by vehicle 208 during charging.

Accordingly, because the response message from charging system host 202 indicates authorization to charge vehicle 208, a single point of authorization is maintained by an operator of electrically powered vehicle charging system 200, including several charging stations 204. More generally, in various embodiments, electrically powered vehicle charging system 200 includes dozens and/or hundreds of charging stations 204 monitored and/or controlled at one charging system host 202. Charging system host 202, therefore, provides a single point of implementing changes to electrically powered vehicle charging system 200 without physically visiting and/or individually changing each of the multiple charging stations 204 included in system 200.

If the return message from charging system host 202 indicates a failed authorization, the charging process is halted without energy transfer from charging station 204 to vehicle 208. If, however, the return message from charging system host 202 indicates successful authorization, charging station 204 proceeds to initiate charging of vehicle 208. In several embodiments, charging station 204 proceeds to transfer energy to vehicle 208 according to one or more parameters. Such parameters may include, without limitation, current, charge time, voltage level, vehicle charge capacity, vehicle type, or other parameters associated with the transfer of energy to vehicle 208 and/or a preference of a user.

In the exemplary embodiment, charging station 204 continues to transfer energy to vehicle 208 until a charge terminate event occurs. A charge terminate event may include a fully charged vehicle or an interrupt event, such as a charging error, a disconnected or damaged charging cable, etc. In response to the charge terminate event, charging station 204 transmits a charge terminate message to charging system host 202. In the exemplary embodiment, the charge terminate message includes a message type and a record type. For a charge terminate message, the message type includes “1” indicating the message is a transaction record, rather than a “0” indicating an authorization request message as described above. The record type includes “0” indicating the transaction is complete or a “1” indicating an interrupted charge. Further, the charge terminate message includes a charge time, a transaction identification number, a disconnect time for vehicle 208, an amount of energy transferred (in kilowatt hours), any errors, an RFID card number, and/or a time/date stamp received in response to the authorization request message. One exemplary format for the charge terminate message is included in Table 1.

TABLE 1

| | | |
|---|---|---|
| Message Type | 1 | byte uint flag |
| Record Type | 1 | byte uint |
| StationIDLocality | 1 | byte uint |
| StationIDFacility | 1 | byte uint |
| StationIDUnit | 2 | byte uint |
| TransactionID | 2 | byte uint |
| Year/Month/Day/Time | 12 | bytes |
| Cardlength | 2 | byte uint |
| Card ID | 32 | byte uint |
| FirmwareVersion | 4 | byte uint |
| HookupTime | 2 | byte uint (minutes) |
| ChargeTime | 2 | byte uint (minutes) |
| ConsumedEnergy | 4 | byte |
| SpareByte | 1 | byte uint |
| ErrorStatusCode | 1 | byte uint |
| ErrorCode | 4 | byte uint |

In this particular example embodiment, HookupTime is the amount of time vehicle 208 is connected to charging station 204, and ChargeTime is the charge time, i.e., the amount of time during which energy was transferred from charging station 204 to vehicle 208. Also, ConsumedEnergy indicates an amount of energy consumed by vehicle 208 during the charging process, and ErrorStatusCode indicates whether or not an error has occurred during the charging process and/or with charging station 204. More specifically, an error status code of “0” indicates no errors, while an error status code of “1” indicates at least one error. ErrorCode provides details about the at least one error associated with the charging process and/or with charging station 204. For example, an error code may indicate that a charging cable was disconnected at some point during a charging process (prior to a complete charge), causing the transfer of energy to vehicle 208 to stop. Further, SpareByte is available for additional information associated with a charging process and/or charging station 204. For example, SpareByte may be employed to provide temperature data associated with charging station 204 and/or vehicle 208 to charging system host 202. It should be appreciated that more or less information and/or various other formats of charge terminate message may be included in other embodiments.

In response to the charge terminate message, charging system host 202 transmits a return message. More specifically, in the example embodiment, the return message includes 0x0003 indicating the transaction was successfully stored, 0x8004 indicating the transaction was not successfully stored, 0x8005 indicating the transaction was not stored due to a format problem, or 0x8006 indicating the transaction is a duplicate. Alternatively, the return message includes 0x8007 indicating the transaction data message type and/or record type were unknown and that the charge terminate message has been ignored. In this exemplary embodiment, charging station 204 responds to at least one return message (e.g., 0x8004) by re-transmitting the charge terminate message. Alternatively, in response to other return messages such as 0x8005 or 0x8006, charging station 204 omits re-transmitting the charge terminate message.

Moreover, if the charge terminate event occurs prior to completing a charging process for vehicle 208, the charging process may be re-initiated for one or more reasons. In the example above, a charging process is re-initiated when a charging cable is re-connected to vehicle 208. When a charging process resumes after a charge terminate event, charging station 204 subsequently transmits at least one additional charge terminate message. Specifically, for example, whenever a charging process is re-initiated, the charging processes ultimately terminate again, due to a charge completion or an error—a charge terminate event. When the subsequent charge terminate event occurs, charging station 204 transmits a subsequent charge terminate message. In the exemplary embodiment, charging station 204 continues to transmit charge terminate messages in response to separate charge terminate events, until the transaction is complete. In this manner, an operator of vehicle 208 is able to associate an entire charging process with a single transaction, despite one or more interruptions during the charging process.

In the exemplary embodiment, charging station 204 periodically transmits a heartbeat message to charging system host 202. The heartbeat message may include any suitable message, which may be received by charging system host 202 to indicate that charging station 204 is operable and connected to network 206. In the exemplary embodiment, the heartbeat message includes a message type (“2” indicating heartbeat message), the frequency of the heartbeat, a station locality identification, a station facility identification, and a station identification unit. In this example, the heartbeat frequency indicates how often the heartbeat message will be transmitted, so that charging system host 202 is able to determine when a heartbeat message was expected and if the heartbeat message is received. It should be appreciated that more or less information may be included in the heartbeat message in other embodiments. For example, the heartbeat message may include a date and/or a time when the heartbeat message was transmitted.

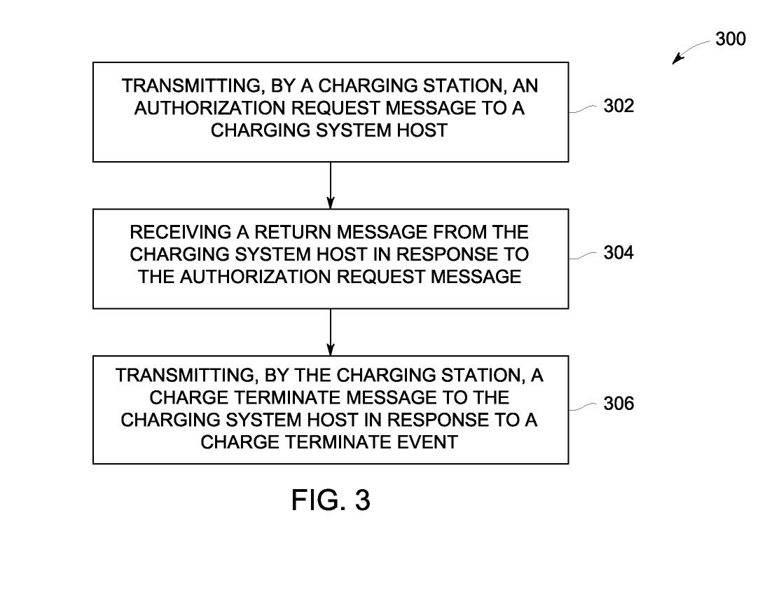

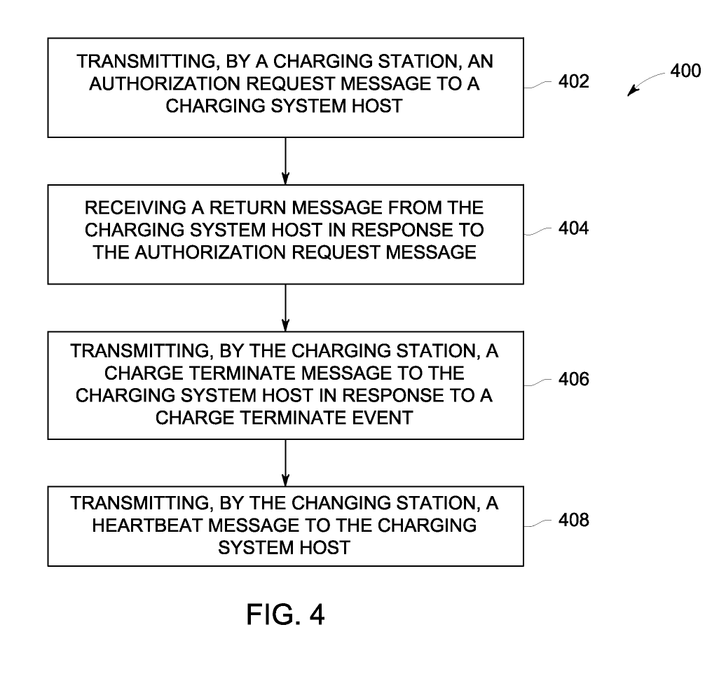

FIGS. 3-4 illustrates exemplary methods 300 and 400 for use in communicating with charging system host 202. While methods 300 and 400 is described herein with reference to electrically powered vehicle charging system 200, it should be appreciated that methods 300 and 400 are not limited to the specific embodiment of electrically powered vehicle charging system 200, but may be employed in other electrically powered vehicle charging systems. Similarly, electrically powered vehicle charging system 200 should not be understood to be limited to methods 300 and 400.

Method 300 includes transmitting 302, by a charging station 204, an authorization request message to charging system host 202, receiving 304 a return message from charging system host 202 in response to the authorization request message, and transmitting 306, by charging station 204, a charge terminate message to charging system host 202 in response to a charge terminate event. The authorization request message includes a charging station identification and a vehicle identification of a vehicle coupled to the charging station. The charge terminate message includes the charging station identification and at least one of a vehicle connection time and a charge time.

In several embodiments, method 300 includes transmitting one or more heartbeat messages to charging system host 202, wherein the heartbeat message includes a charging station identification. Additionally, method 300 includes receiving a return message from charging system host 202, in response to the heartbeat message, indicating receipt of the heartbeat message. In various embodiments, method 300 includes receiving a return message from the charging system host, in response to the charge terminate message, indicating the charge terminate message has been received. In some embodiment, method 300 includes transmitting a second charge terminate message after a vehicle is disconnected from the charging station.

Referring to FIG. 4, method 400 transmitting 402, by a charging station 204, an authorization request message to charging system host 202, receiving 404 a return message from charging system host 202 in response to the authorization request message, and transmitting 406, by charging station 204, a charge terminate message to charging system host 202 in response to a charge terminate event, and transmitting 408 a heartbeat messages to charging system host 202. The authorization request message includes a charging station identification and a vehicle identification of a vehicle coupled to the charging station, and the charge terminate message includes the charging station identification and at least one of a vehicle connection time and a charge time. The heartbeat message includes a charging station identification.

As described herein, systems and methods for use in communicating information between a charging system host and a plurality of vehicle charging stations are provided. More specifically, systems and methods for communicating authorization and/or transaction information to and/or from a charging station from and/or to a charging system host through a network are provided. In this manner, several charging stations are able to communicate with a charging system host to transmit authorization request messages, charge terminate messages for monitoring charging transaction at each of the charging stations, and heartbeat messages for monitoring the health of the multiple charging station. Accordingly, an efficient and centralized charging system host may provide enhanced monitoring and control of an electrically powered vehicle charging system, as compared to known systems and methods. Furthermore, the methods and systems described herein may permit the association of an entire charging process with a single transaction, despite one or more interruptions during the charging process.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other systems and methods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer based method for use in communicating with a charging system host, said method comprising:
transmitting, by a charging station, an authorization request message to a charging system host, wherein the authorization request message includes a charging station identification and a vehicle identification of a vehicle coupled to the charging station;
receiving a return message from the charging system host in response to the authorization request message; and
transmitting, by the charging station, a charge terminate message to the charging system host in response to a charge terminate event, wherein the charge terminate message includes the charging station identification and at least one of a vehicle connection time and a charge time.

2. The method of claim 1, further comprising transmitting a heartbeat message to the charging system host, wherein the heartbeat message includes a charging station identification.

3. The method of claim 2, wherein transmitting the heartbeat message comprises transmitting a plurality of heartbeat messages, each heartbeat message including a heartbeat frequency.

4. The method of claim 2, further comprising receiving a second return message from the charging system host, in response to the heartbeat message, indicating receipt of the heartbeat message.

5. The method of claim 1, further comprising receiving a second return message from the charging system host, in response to the charge terminate message, indicating the charge terminate message has been received.

6. The method of claim 1, wherein transmitting the charge terminate message comprises transmitting the charge terminate message including a transaction identification and an amount of energy consumed.

7. The method of claim 1, further comprising reading, at an input interface, the vehicle identification from a radio-frequency identification (RFID) card associated with the vehicle.

8. The method of claim 1, wherein transmitting the charge terminate message comprises transmitting the charge terminate message including a date and a time associated with the charge terminate event.

9. The method of claim 8, wherein transmitting the charge terminate message comprises transmitting the charge terminate message including at least one error code associated with the charge terminate event.

10. The method of claim 8, wherein the charging station identification includes at least one of a locality identification and a facility identification.

11. The method of claim 10, wherein transmitting the authorization request message to the charging system host comprises transmitting the authorization request message to the charging system host having a static network address.

12. The method of claim 1, wherein the charge terminate event includes a charge interruption, said method further comprising transmitting a second charge terminate message after a vehicle is disconnected from the charging station.

13. A charging station for use in communicating with a charging system host, said charging station comprising:
a memory device configured to store a charge station identification;
a communication interface configured to communicate with a charging system host through a network; and
a processor electrically coupled to said memory device and to said communication interface, said processor programmed to:
transmit, via said communication interface, an authorization request message to a charging system host, wherein the authorization request message includes the charging station identification and a vehicle identification of a vehicle coupled to the charge station;
receive a return message from the charging system host in response to the authorization request message; and
transmit, via said communication interface, a charge terminate message to a charging system host in response to a charge terminate event, wherein the charge terminate message includes the charging station identification and at least one of a vehicle connection time and a charge time.

14. The charging station of claim 13, further comprising an input interface configured to read a radio-frequency identification (RFID) card, wherein the processor is programmed to read, via the input interface, the vehicle identification from the radio-frequency identification (RFID).

15. The charging station of claim 13, wherein the processor is programmed to transmit the authorization request message and the charge terminate message to the charging system host at a static network address.

16. The charging station of claim 13, wherein the return message includes a date and a time, and wherein the processor is programmed to store the data and the time in said memory device.

17. The charging station of claim 13, wherein the charge terminate message includes a transaction identification and an amount of energy consumed.

18. The charging station of claim 13, wherein the processor is programmed to periodically transmit a heartbeat message including a charging station identification.

19. The charging station of claim 18, wherein the charge terminate message includes the vehicle connection time and the charge time.

20. The charging station of claim 13, wherein the charging station identification includes at least one of a locality identification and a facility identification.
